(19) United States
(12) Patent Application Publication
(10) Pub. No.: US 2023/0297687 A1
(43) Pub. Date: Sep. 21, 2023

(54) OPPORTUNISTIC HARDENING OF FILES TO REMEDIATE SECURITY THREATS POSED BY MALICIOUS APPLICATIONS

(71) Applicant: VMware, Inc., Palo Alto, CA (US)

(72) Inventors: Shivali SHARMA, Pune (IN); Raunak Ravindra SINGWI, Pune (IN); Kedar Bhalchandra CHAUDHARI, Pune (IN); Akeem Lamar JENKINS, Broomfield, CO (US)

(21) Appl. No.: 17/655,779

(22) Filed: Mar. 21, 2022

(51) Int. Cl. G06F 21/57; G06F 21/56

(52) U.S. Cl. CPC G06F 21/577; G06F 21/566; G06F 2221/033; G06F 2221/2141

(57) ABSTRACT

A method for assigning permissions to files in a malware detection system, is provided. The method generally includes assigning a first subset of permissions to a first file classified as an unknown file, opening the first file in accordance with the first subset of permissions, determining a first verdict for the first file, the first verdict indicating the first file is benign, assigning a second subset of permissions to the first file based on determining the first verdict indicating the first file is benign, and executing the first file in accordance with the second subset of permissions.

### BACKGROUND

Today’s enterprises rely on defense-in-depth mechanisms (e.g., multiple layers of security defense controls used to provide redundancy in the event a security control fails) to protect endpoint computing devices from malware infection. Malware is malicious software that, for example, disrupts network operations and gathers sensitive information on behalf of an unauthorized third party. Targeted malware may employ sophisticated methodology and embed in the target’s infrastructure to carry out undetected malicious activities. In particular, once malware gains access to an endpoint, the malware may attempt to control the device and use lateral movement mechanisms to spread to other endpoints and critical assets of an enterprise.

Anti-malware solutions are employed to detect and prevent malware from infiltrating such endpoint computing devices in a system using various techniques, such as, sandboxing of malware samples, signature based detection of known malwares, and blocking of malwares from spreading in the environment.

Sandboxing is a software management strategy used to identify zero day malware threats (e.g., threats not previously known about or anticipated). In particular, sandboxing proactively detects malware by executing files in a safe and isolated environment to observe that file’s behavior and output activity. As used herein, a file that is analyzed may include a file opened by another application, an executable application or code, and/or the like. Traditional security measures are reactive and based on signature detection - which works by looking for patterns identified in known instances of malware. Because traditional security measures detect only previously identified threats, sandboxes add another layer of security.

While sandboxing techniques are used for dynamic malware analysis, static malware analysis involves analyzing and/or scanning of files to determine any malicious behavior. Performing static analysis is a way to detect malicious code or infections within the file. In particular, static analysis may involve parsing data, extracting patterns, attributes and artifacts, and flagging anomalies.

Static malware analysis and/or dynamic malware analysis (e.g., with the use of sandboxing techniques) of files may be used to derive and return a verdict, such as BENIGN, MALICIOUS, etc., for the file. For example, where the static and/or dynamic analysis finds that the executed file modifies system files and/or infects the system in any way, those issues may not spread to other areas given the isolated nature of the sandbox environment. Accordingly, a verdict of MALICIOUS may be assigned to the file indicating the sample is malware and poses a security threat. On the other hand, where the static and/or dynamic analysis finds that the executed file is safe and does not exhibit malicious behavior, a verdict of BENIGN may be assigned. Such derived verdicts may be used to take appropriate policy action, for example, to enable blocking or access to the files by endpoints in the system.

In some cases, while performing analyses on an unknown file to ascertain a verdict for the file, one strategy includes quarantining the file until analysis is complete and a verdict for the file has been returned. In other words, the file may be held in isolation on an endpoint and not be permitted to execute until the file is determined to be safe or unsafe for execution. While static and dynamic malware analyses are useful tools that can effectively detect unknown or zero-day threats, such analyses are time-consuming activities (and in some cases, are computationally expensive). Accordingly, in this case, the file may be quarantined for an amount of time which adversely affects the experience of a user attempting to access and/or execute the file, as well as developer productivity. For example, a user attempting to open a file having an unknown verdict may need to wait an undesirable about of time, for example, until a verdict for the file is published, prior to being able to open the file.

Accordingly, in some cases as an alternative to quarantining the file, the unknown file may be opened (e.g., allowed to execute, accessed, etc.) while static and/or dynamic malware analyses are asynchronously being performed to ascertain a verdict for the file. This approach enhances user experience by not requiring a verdict prior to access and/or execution of the file. However, in cases where the file is, in fact, malware, this approach increases the risk of attack on the endpoint, as well as, increases the likelihood of a malicious file spreading and compromising other endpoints in the environment.

Further, by the time a verdict for the file is returned indicating that the file is MALICIOUS, the file may have compromised multiple endpoints in the environment. At this point, it may be unclear which endpoints in the environment the MALICIOUS file has compromised and/or where the MALICIOUS file has spread. Accordingly, clean-up of the malware and its traces may become tedious. Further, it may be unclear whether the clean-up was a success or whether the malware still exists in the environment.

It should be noted that the information included in the Background section herein is simply meant to provide a reference for the discussion of certain embodiments in the Detailed Description. None of the information included in this Background should be considered as an admission of prior art.

### BRIEF DESCRIPTION OF THE DRAWINGS

FIG. 1 depicts example physical and virtual components in a networking environment in which embodiments of the present disclosure may be implemented.

FIGS. 2A and 2B illustrate an example workflow for evaluating unknown files in a distributed malware detection system, according to an example embodiment of the present application.

FIG. 3 illustrates an example workflow for determining hardening policies to apply to unknown files, according to an example embodiment of the present application.

### DETAILED DESCRIPTION

Aspects of the present disclosure provide an approach for opportunistic hardening and relaxation of policies applied when opening files with unknown verdicts in a malware detection system. Though certain aspects are described with respect to files, it should be noted that the techniques discussed herein may similarly be applied to binaries, applications, and the like. As mentioned, an unknown verdict may be an initial verdict for a file which has not yet been analyzed by the malware detection system. In certain aspects, the malware detection system described herein involves decentralized architecture where resources on two or more endpoints (e.g., a server, a host, etc.) are leveraged to isolate and examine unknown files and produce a verdict regarding the safety of each file. A file may be “unknown” when the file has not previously been identified as BENIGN or MALICIOUS, such as based on a previous verification.

The goal of hardening is to reduce security risk by eliminating potential attack vectors and condensing a system’s attack surface (e.g., the combination of all possible points, or attack vectors, which an unauthorized user may exploit). Accordingly, hardening policies may be implemented herein to reduce a system’s vulnerability to attack by an unknown file, which may contain malware seeking to compromise the integrity of the system. The hardening policies may include a set of permissions assigned to the file, where the set of permissions indicates the authorization given to a file to access specific resources, such as central processing unit (CPU), memory, storage, and the like. Permissions assigned to the file may also designate the type of access to such resources. For example, permissions with respect to storage resources may indicate whether data in storage may only be viewed (e.g., read only access) by the file or updated too (e.g., read and write access). In certain aspects, the hardening policies may contain a reduced (e.g., minimum) set of permissions which ensure that resources of the system cannot be compromised in cases where a MALICIOIUS file is encountered, while still allowing the file to be opened. Accordingly, the reduced set of permissions described herein may not be tied to the properties of the file for which the permissions are to apply, but instead to the security of the system. In particular, in certain aspects, hardening policies may refer to a limited set of permissions that includes less permissions or more restrictive permissions, thereby reducing resource access of the system by the file. These less permissions or more restrictive permissions granting reduced resource access may be relative to relaxed policies that include more permissions or less restrictive permissions, thereby increasing resource access of the system by the file as compared to the hardening policies.

The hardening policies described herein may be applied after determining that the file is classified as an unknown file, but before categorization of the file as “safe” (e.g., BENIGN) or “unsafe” (e.g., MALICIOUS). The application of such hardening policies prior to categorizing the file as BENIGN or MALICIOUS, may allow for the immediate execution of the unknown file with the applied hardening policies, thereby mitigating the security risk imposed by the file, should the file contain malware. For example, the file may be opened on a machine with the hardening policies applied, such as a physical computing device directly, or on a virtual machine (VM) (e.g., an instance of an operating system (OS) that is managed centrally on an endpoint and executed locally on a user device) or other virtual computing instance (VCI). Accordingly, aspects described herein may help to maintain the balance between security and user experience, as well as developer productivity (e.g., as opposed to quarantining the file or allowing the file to execute with permissions which may harm the system, as used in conventional techniques described previously herein).

Further, the hardening policies may be relaxed after a verdict of BENIGN is returned for the file (e.g., following completion of static analysis and/or dynamic analysis of the file). Accordingly, the relaxed policies may be applied during execution of the file subsequent to classification of the file as BENIGN. The relaxed policies may contain a greater number of permissions as compared to permissions provided by previously applied hardening policies. In certain aspects, the relaxed policies may be based on a score assigned to the file during static and/or dynamic analysis. In certain aspects, the score may represent a confidence level of a component performing the static and/or dynamic analysis in identifying that the file is safe or unsafe. In certain aspects, the score may represent a threat level of the file, wherein such threat levels fall between a known BENIGN file threat (e.g., a score of zero) and an unknown BENIGN file threat (e.g., a score of ten).

For example, two unknown files may be opened with similar hardened policies applied which, at least, restrict network access by the files while the files continue to be classified as unknown. However, a verdict of BENIGN may be returned for each file after performing static and/or dynamic analysis for such files, accordingly, such hardening policies may be relaxed. While hardening policies for the first file may be relaxed such that only partial network access permission is provided to the first file, the second file may not be restricted with respect to network access. Network access permissions may be increased more for the second file as compared to the first file where the score assigned to the second file indicates a greater confidence that the second file is, indeed, BENIGN as compared to the confidence score assigned to verdict for the first file.

Further, in certain aspects, prior to allowing execution and/or access to a file on a device (e.g., machine), snapshot features may be enabled for backup and protection purposes. Snapshots provide the ability to capture a point-in-time state and data of the device (e.g., such as a VM) prior to opening an unknown file, to restore the device to known working, uncompromised points where a verdict returned for the file indicates the file is MALICIOUS. For example, a snapshot taken prior to execution of an unknown file may entirely, or in part, represent data blocks that existed for the device when the snapshot was created. Accordingly, where the unknown file contains malware, the unknown file may delete, modify, create, etc. one or more data blocks during execution of the file (e.g., where hardening policies applied allow for such activity) prior to receiving the MALICIOUS verdict for the file. Thus, the snapshot may be used to restore data blocks to the unmodified state, as if the MALICIOUS file was never allowed to execute in the first place.

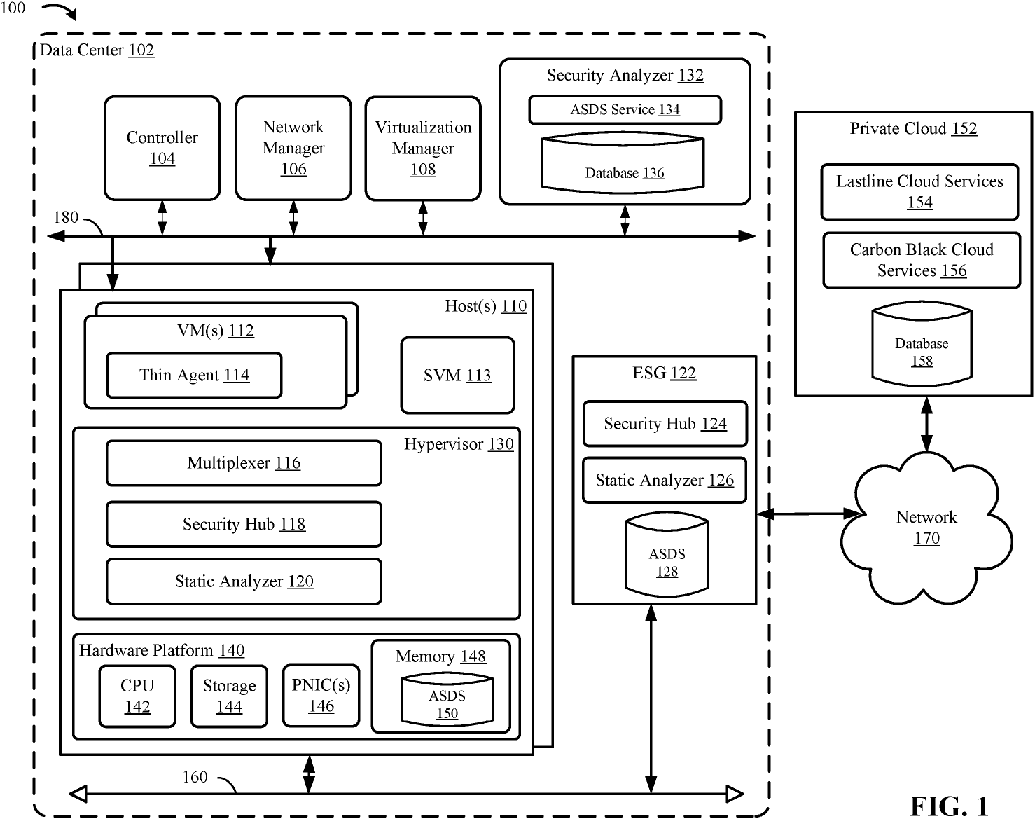

FIG. 1 depicts example physical and virtual network components in a networking environment 100 in which embodiments of the present disclosure may be implemented. As shown in FIG. 1, networking environment 100 may be distributed across a hybrid cloud. A hybrid cloud is a type of cloud computing that combines on-premises infrastructure, e.g., a private cloud 152 comprising one or more physical computing devices (e.g., running one or more VCIs) on which the processes shown run, with a public cloud, or data center 102, comprising one or more physical computing devices (e.g., running one or more VCIs) on which the processes shown run. Hybrid clouds allow data and applications to move between the two environments. Many organizations choose a hybrid cloud approach due to organization imperatives such as meeting regulatory and data sovereignty requirements, taking full advantage of on-premises technology investment, or addressing low latency issues.

Data center 102 and private cloud 152 may communicate via a network 170. Network 170 may be an external network. Network 170 may be a layer 3 (L3) physical network. Network 170 may be a public network, a wide area network (WAN) such as the Internet, a direct link, a local area network (LAN), another type of network, or a combination of these.

Data center 102 includes one or more hosts 110, an edge services gateway (ESG) 122, a management network 180, a data network 160, a controller 104, a network manager 106, a virtualization manager 108, and a security analyzer 132. Data network 160 and management network 180 may be implemented as separate physical networks or as separate virtual local area networks (VLANs) on the same physical network.

Host(s) 110 may be communicatively connected to both data network 160 and management network 180. Data network 160 and management network 180 are also referred to as physical or “underlay” networks, and may be separate physical networks or the same physical network as discussed. As used herein, the term “underlay” may be synonymous with “physical” and refers to physical components of networking environment 100. As used herein, the term “overlay” may be used synonymously with “logical” and refers to the logical network implemented at least partially within networking environment 100.

Each of hosts 110 may be constructed on a server grade hardware platform 140, such as an x86 architecture platform. Hosts 110 may be geographically co-located servers on the same rack or on different racks. Hardware platform 140 of a host 110 may include components of a computing device such as one or more processors (CPUs) 142, storage 144, one or more network interfaces (e.g., physical network interface cards (PNICs) 146), system memory 148, and other components (not shown). A CPU 142 is configured to execute instructions, for example, executable instructions that perform one or more operations described herein and that may be stored in the memory and storage system. The network interface(s) enable host 110 to communicate with other devices via a physical network, such as management network 180 and data network 160.

Each host 110 is configured to provide a virtualization layer, also referred to as a hypervisor 130. Hypervisors abstract processor, memory, storage, and networking physical resources of hardware platform 140 into a number of VCIs or VMs 112(1)...(x) (collectively referred to as VMs 112) on hosts 110. As shown, multiple VMs 112 may run concurrently on the same host 110.

In certain aspects, the processor, memory, storage, and networking physical resources of hardware platform 140 are abstracted into a service VM (SVM) 113. SVM 113 is a VM that is also executed on host 110 and is used for providing a service to at least a subset of VMs 112 (e.g., guest VMs). Each host 110 may include an SVM 113.

As described in more detail below, SVM 113 may be configured to protect VMs 112 running on host 110 by taking appropriate action in accordance with one or more policies. As described in more detail below, policies may be configured at hosts 110 and ESG 122 to indicate what action is to be taken when a file is determined to be MALICIOUS. Further, in certain aspects, SVM 113 may be configured to determine hardening policies to be applied to unknown files and relaxed policies to be applied to files classified as BENIGN. Additionally, in certain aspects, SVM 113 may communicate with a security analyzer 132, a controller 104, and/or a network manager 106 in data center 102 (e.g., operations performed by security analyzer 132, controller 104, and/or network manager 106 are described in more detail below) which may be configured to determine such hardening and/or relaxed policies. In particular, a user may inform security analyzer 132, controller 104, and/or network manager 106 of its intended security and/or risk level, and security analyzer 132, controller 104, and/or network manager 106 may be configured to determine hardening policies and/or relaxed policies to be applied to files based on this input. Security analyzer 132, controller 104, and/or network manager 106 may communicate such hardening and/or relaxed policies to SVM 113 for application of the hardening policies to unknown files and/or the relaxed policies to files determined to be BENIGN. As described in more detail below, hardening policies and/or relaxed policies may be determined based on one or more factors, and such policies may contain one or more permissions assigned to a file when opening the file.

Each hypervisor 130 may run in conjunction with an operating system (OS) in its respective host 110. In some embodiments, hypervisors can be installed as system level software directly on hardware platforms of its respective host 110 (e.g., referred to as “bare metal” installation) and be conceptually interposed between the physical hardware and the guest OSs executing in the VMs 112. Though certain aspects are described herein with respect to VMs 112 running on host machines 110, it should be understood that such aspects are similarly applicable to physical machines, like host machines 110, without the use of virtualization.

ESG 122 is configured to operate as a gateway device that provides components in data center 102 with connectivity to an external network, such as network 170. ESG 122 may be addressable using addressing of the physical underlay network (e.g., data network 160). ESG 122 may manage external public IP addresses for VMs 112. ESG 122 may include a router (e.g., a virtual router and/or a virtual switch) that routes traffic incoming to and outgoing from data center 102. ESG 122 also provides other networking services, such as firewalls, network address translation (NAT), dynamic host configuration protocol (DHCP), and load balancing. ESG 122 may be referred to as a nested transport node, for example, as the ESG VM 122 does encapsulation and decapsulation. ESG 122 may be a stripped down version of a Linux transport node, with the hypervisor module removed, tuned for fast routing. The term, “transport node” refers to a virtual or physical computing device that is capable of performing packet encapsulation/decapsulation for communicating overlay traffic on an underlay network.

While ESG 122 is illustrated in FIG. 1 as a component outside of host 110, in some embodiments, ESG 122 may be situated on host 110 and provide networking services, such as firewalls, NAT, DHCP, and load balancing services as an SVM.

In certain embodiments, a security hub, a static analyzer, and an advance signature distribution service (ASDS) cache may be implemented on one or more hosts 110 and/or ESG 122 for the purpose of detecting malware and other security threats in data center 102.

In particular, a static analyzer may be implemented in data center 102 to perform static analysis of files on each of hosts 110 and/or ESG 122. Such files may be analyzed, for example, when downloaded to a host 110 or ESG 122, when added to a host 110 or ESG 122, before execution on a host 110 or ESG 122, and/or the like. Static analysis is performed for quick scanning of files to determine any malicious behavior. Performing static analysis is a way to detect malicious code or infections within the file.

The static analyzer implemented in data center 102 may run in isolated user spaces on multiple hosts 110 and/or ESGs 122, the isolated user spaces generally referred to as containers. Each container is an executable package of software running on top of a host 110 OS or ESG 122. In certain aspects, each host 110 and/or ESG 122 in data center 102 and/or private cloud 152 is used to run a static analyzer in a container. In certain aspects, a subset of hosts 110 and/or ESGs 122 in data center 102 and/or private cloud 152 is used to run a static analyzer in a container. In certain aspects, the static analyzer is implemented in a single container on a given host 110 and/or ESG 122. In certain aspects, the static analyzer is implemented on multiple containers on a given host 110 and/or ESG 122 In other words, one or more containers per endpoint (e.g., host 110 and/or ESG 122) are used to perform static analysis as a distributed application. Thus, distributed static analysis may be performed by the example implementation illustrated in FIG. 1. As shown in FIG. 1, ESG 122 may include static analyzer 126, and hypervisor 130 of host 110 may include static analyzer 120. While static analyzer 120 is implemented as a component on hypervisor 130, in some other embodiments, static analyzer 120 may be implemented in a VM such as SVM 113 on host 110 (e.g., along with security hub 118 and ASDS cache 150, described in more detail below), or on an OS of host 110.

To execute such static analysis on each host 110 where static analyzer 120 is running, a thin agent 114 (also referred to as a “guest introspection thin agent”), a multiplexer 116, and a security hub 118 are implemented. More specifically, thin agent 114 may be implemented as a component on each VM 112, while multiplexer 116 and security hub 118 may be implemented as components on hypervisor 130 of host 110. According to certain aspects described herein, thin agent 114 running within a VM 112 intercepts files, processes, network events, etc. on VM 112 and provides these files, processes, network events, etc. to multiplexer 116. For example, thin agent 114 may register with a guest OS running on VM 112 to receive information about such events from the guest OS. Multiplexer 116 then provides such information to security hub 118. Security hub 118 may be configured to retrieve verdicts for known files on host 110. A known file may refer to a file for which a verdict is known, such as through a previous inspection or sandboxing. Security hub 118 may retrieve verdicts from ASDS cache 150 stored in physical memory (e.g., random access memory (RAM)) configured within host 110. ASDS cache 150 acts as small, fast memory that store files hashes for recently accessed and inspected files and their associated verdicts. Security hub 118 may use ASDS cache 150 to retrieve verdicts for previously inspected files without accessing database 136 stored on security analyzer 132, which is described in more detail below. Accordingly, data requests satisfied by the cache are executed with less latency as the latency associated with accessing database 136 is avoided.

Alternatively, to execute such static analysis on ESG 122 where static analyzer 126 is running, a plugin (not shown) (e.g., a software component configured to perform particular function(s)) and a security hub 124 are implemented. More specifically, the plugin and security hub 124 may be implemented on ESG 122. According to certain aspects described herein, a plugin may intercept network packets at ESG 122 and provide these network packets to security hub 124. Security hub 124 may be configured to retrieve verdicts for known files on ESG 122. A known file may refer to a file for which a verdict is known, such as through a previous inspection or sandboxing. Security hub 124 may retrieve verdicts from ASDS cache 128 stored on ESG 122.

According to certain aspects described herein, security hubs 118, 124 may also be configured to select files on each of hosts 110 and ESG 122, respectively, for analysis. For example, security hub 124 implemented on ESG 122 may interact with a network intrusion detection and prevention system (IDPS) (e.g., used to monitor network activities for malicious activity) to determine which files are to be analyzed. Similarly, security hub 118 implemented on hypervisor 130 of host 110 may interact with VMs 112 to determine which files are to be analyzed. Security hubs 118, 124 may trigger the static analysis of such files.

Data center 102 includes a management plane and a control plane. The management plane and control plane each may be implemented as single entities (e.g., applications running on a physical or virtual compute instance), or as distributed or clustered applications or components. In alternative embodiments, a combined manager/controller application, server cluster, or distributed application, may implement both management and control functions. In the embodiment shown, network manager 106 at least in part implements the management plane and controller 104 at least in part implements the control plane

The control plane determines the logical overlay network topology and maintains information about network entities such as logical switches, logical routers, and endpoints, etc. The logical topology information is translated by the control plane into network configuration data that is then communicated to network elements of host(s) 110. Controller 104 generally represents a control plane that manages configuration of VMs 112 within data center 102. Controller 104 may be one of multiple controllers executing on various hosts in the data center that together implement the functions of the control plane in a distributed manner. Controller 104 may be a computer program that resides and executes in a central server in the data center or, alternatively, controller 104 may run as a virtual appliance (e.g., a VM) in one of hosts 110. Although shown as a single unit, it should be understood that controller 104 may be implemented as a distributed or clustered system. That is, controller 104 may include multiple servers or virtual computing instances that implement controller functions. It is also possible for controller 104 and network manager 106 to be combined into a single controller/manager. Controller 104 collects and distributes information about the network from and to endpoints in the network. Controller 104 is associated with one or more virtual and/or physical CPUs (not shown). Processor(s) resources allotted or assigned to controller 104 may be unique to controller 104, or may be shared with other components of the data center. Controller 104 communicates with hosts 110 via management network 180, such as through control plane protocols. In some embodiments, controller 104 implements a central control plane (CCP).

Network manager 106 and virtualization manager 108 generally represent components of a management plane comprising one or more computing devices responsible for receiving logical network configuration inputs, such as from a user or network administrator, defining one or more endpoints and the connections between the endpoints, as well as rules governing communications between various endpoints.

In some embodiments, virtualization manager 108 is a computer program that executes in a central server in the data center (e.g., the same or a different server than the server on which network manager 106 executes), or alternatively, virtualization manager 108 runs in one of VMs 112. Virtualization manager 108 is configured to carry out administrative tasks for data center 102, including managing hosts 110, managing VMs running within each host 110, provisioning VMs, transferring VMs from one host 110 to another host 110, transferring VMs between data centers 102, transferring application instances between VMs or between hosts 110, and load balancing among hosts 110 within data center 102. Virtualization manager 108 takes commands as to creation, migration, and deletion decisions of VMs and application instances on the data center. However, virtualization manager 108 also makes independent decisions on management of local VMs and application instances, such as placement of VMs and application instances between hosts 110. In some embodiments, virtualization manager 108 also includes a migration component that performs migration of VMs between hosts 110, such as by live migration.

In some embodiments, network manager 106 is a computer program that executes in a central server in networking environment 100, or alternatively, network manager 106 may run in a VM 112, e.g., in one of hosts 110. Network manager 106 communicates with host(s) 110 via management network 180. Network manager 106 may receive network configuration input from a user or an administrator and generate desired state data that specifies how a logical network should be implemented in the physical infrastructure of the data center. Further, in certain embodiments, network manager 106 may receive security configuration input (e.g., security policy information) from a user or an administrator and configure hosts 110 and ESG 122 according to this input. As described in more detail below, policies configured at hosts 110 and ESG 122 may indicate what action is to be taken when a file is determined to be BENIGN or MALICIOUS.

Network manager 106 is configured to receive inputs from an administrator or other entity, e.g., via a web interface or application programming interface (API), and carry out administrative tasks for the data center, including centralized network management and providing an aggregated system view for a user.

In certain embodiments, a security analyzer 132 may be implemented as an additional component of the management plane. Security analyzer 132 may maintain a database 136 of verdicts for files inspected by hosts 110 and/or ESG 122. In certain embodiments, database 136 stores file hashes and associated verdicts produced by one or more hosts 110 and/or ESG 122 for each of the files inspected. It should be noted that different embodiments may implement different data structures for maintaining file hashes and associated verdicts, and that any suitable data structure(s) may be used, including other tables, arrays, bitmaps, hash maps, etc.

Security analyzer 132 may also maintain in its database 136, verdicts produced by other trusted sources, which may be stored in any suitable data structure(s). Examples of other trusted sources that are implemented to inspect files and provide verdicts for such files include Lastline cloud services 154 and Carbon Black cloud services 156 made commercially available from VMware, Inc. of Palo Alto, California. Lastline cloud services 154 and Carbon Black cloud services 156 provide security software that is designed to detect malicious behavior and help prevent malicious files from attacking an organization. Though certain aspects are described with respect to Lastline cloud services 154 and Carbon Black cloud services 156, any similar dynamic analyzer may be used according to the techniques discussed herein. In particular, Lastline cloud services 154 and Carbon Black cloud services 156 may be implemented to perform dynamic analysis of files. Dynamic analysis monitors the actions of a file when the file is being executed. Dynamic analysis may also be referred to as behavior analysis because the overall behavior of the sample is captured in the execution phase. Lastline cloud services 154 and Carbon Black cloud services 156 may perform dynamic analysis in a “sandbox”, or in other words, an isolated environment, to ensure that components of data center 102 are not affected in cases where the file executed for analysis contains malware (e.g., is a MALICIOUS file).

Such files may be analyzed by Lastline cloud services 154 and Carbon Black cloud services 156 where static analyzer 120, 126 determines additional analysis is desired. For example, static analyzer 120, 126 may perform static analysis and return a verdict of BENIGN for a file; however, a confidence level associated with the BENIGN verdict produced by static analyzer 120, 126 may be below a threshold confidence level; thus, to ensure the file is BENIGN, static analyzer 120, 126 may determine dynamic analysis is warranted by Lastline cloud services 154 and/or Carbon Black cloud services 156. Accordingly, Lastline cloud services 154 and/or Carbon Black cloud services 156 may perform dynamic analysis for the file to produce a verdict for the file. The verdict produced by Lastline cloud services 154 and/or Carbon Black cloud services 156 may take precedence over a verdict produced by static analyzer 120 on host 110 or static analyzer 126 on ESG 122 for the same file (e.g., where the verdicts are different). In this case, only the verdicts produced by Lastline cloud services 154 and Carbon Black cloud services 156 may be stored in database 158 on private cloud 152, as well as in database 136 and ASDS caches 150, 128 of hosts 110 and ESG 122, respectively.

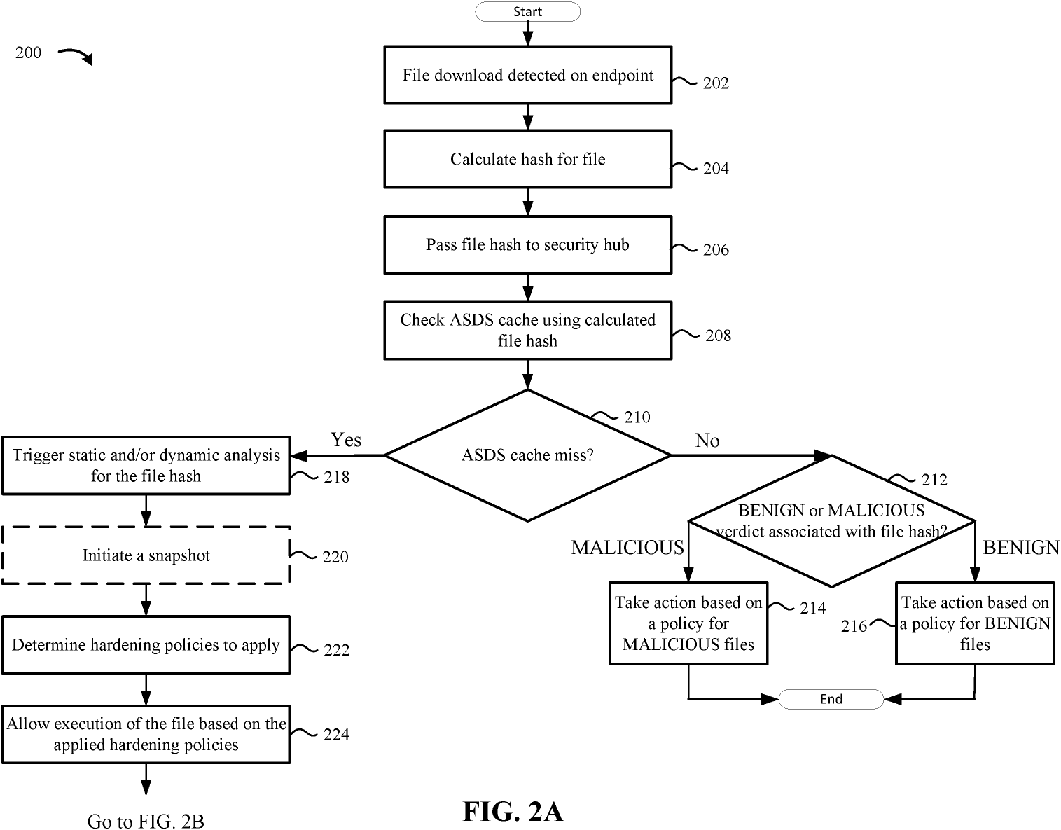

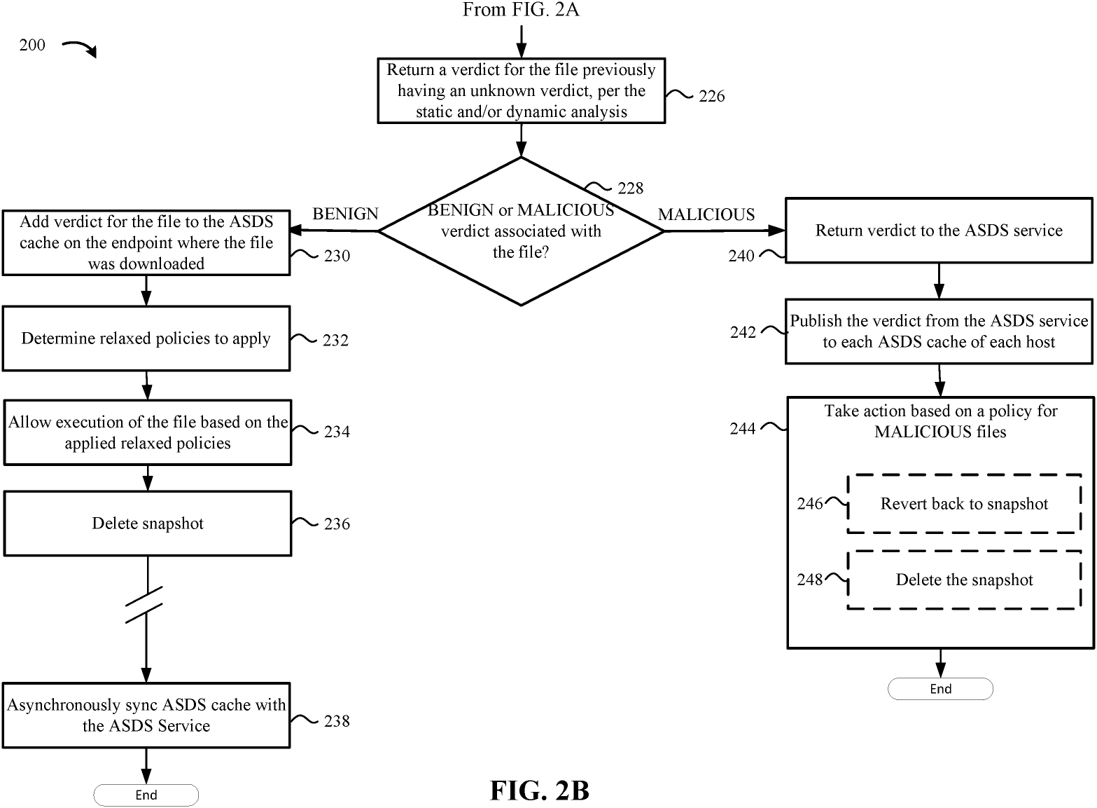

FIGS. 2A and 2B illustrate an example workflow 200 for evaluating unknown files in a distributed malware detection system, according to an example embodiment of the present application. Workflow 200 of FIGS. 2A and 2B may be performed, for example, by components of networking environment 100 illustrated in FIG. 1.

Workflow 200 may be used to identify, generate, and/or report verdicts for files at one or more endpoints in a networking environment configured with distributed anti-malware capability. As used herein, an endpoint may be any device, such as host 110, ESG 122, etc. illustrated in FIG. 1. Further, workflow 200 may be used to identify a file with an unknown verdict, determine and apply hardening policies to the unknown file, trigger malware analysis for the file, and allow for relaxation of such hardening policies where a verdict returned for the file is BENIGN. As described previously, to ensure optimal user experience, as well as developer productivity, the hardening policies implemented while the file is being analyzed may allow a user to open the file with a reduced (e.g., minimum) set of permissions needed for execution of the file, as opposed to quarantining the file until a verdict is published. Application of the hardening policies may also allow for opening of the file although it is unknown whether the file is safe for execution (e.g., unknown whether the file contains malware). However, the security risk imposed by allowing a user to open an unknown file may be mitigated by limiting the permissions allocated to the file (e.g., via hardening policies applied to the file)

Workflow 200 begins, at operation 202, by an endpoint, such as VM 112 on host 110 or ESG 122 in data center 102 illustrated in FIG. 1, downloading one or more files. In some other cases (not shown), workflow 200 may begin by a file being added to a host 110 or ESG 122, prior to execution of a file on a host 110 or ESG 122, and/or the like. While the illustrated example assumes only one file is downloaded at the endpoint, in some other cases, multiple files may be downloaded at the endpoint and each file analyzed using workflow 200. The endpoint downloading the file may be referred to herein as the initiator endpoint given a file download initiates workflow 200 for malware detection. At operation 204, a hash is calculated for the downloaded file. In particular, for each file, a corresponding unique hash of the file may be generated, for example by using a cryptographic hashing algorithm such as the SHA-1 algorithm.

Where the file is downloaded on VM 112 on host 110, a thin agent on VM 112, for example, thin agent 114 illustrated in FIG. 1, may be configured to intercept the file and transfer a hash calculated for the file to a multiplexer, such as multiplexer 116 illustrated in FIG. 1. Accordingly, multiplexer 116, at operation 206, passes the calculated hash to a security hub, such as security hub 118 illustrated in FIG. 1. Alternatively, where the file is downloaded on ESG 122, a plugin may be used to intercept the file and, at operation 206, pass a calculated hash for the file to a security hub.

The security hub may be a security hub implemented at the initiator endpoint or another endpoint (e.g., in cases where the initiator endpoint is not configured with a security hub). For example, the security hub may be security hub 118 implemented on host 110 as illustrated in FIG. 1 when the initiator endpoint is (1) a VM 112 on host 110 where security hub 118 is implemented or (2) a VM 112 on host 110 where security hub 118 is not implemented. In some other examples, the security hub may be security hub 124 implemented on ESG 122 as illustrated in FIG. 1, such as when the initiator endpoint is ESG 122. Accordingly, though certain processes described herein for retrieving verdicts, performing static and/or dynamic analysis, etc., are described as occurring at the initiator endpoint, they may instead occur at a different endpoint

As mentioned, security hubs 118, 124 may be configured to retrieve verdicts for known files (files known to be BENIGN or MALICIOUS based on prior inspection for malware content) from a cache at the initiator or other endpoint storing hash values and verdicts for previously inspected files. For example, the cache may be ASDS cache 150 at host 110 illustrated in FIG. 1 when the initiator or other endpoint is a VM 112 on host 110. In some other examples, the cache may be ASDS cache 128 at ESG 122 illustrated in FIG. 1 when the endpoint is ESG 122.

ASDS caches 150, 128 may store verdicts (and associated security attributes) for files (e.g., each identified by a unique hash value) that have been returned or published to endpoints in the environment. For example, a BENIGN file verdict for a file may have been prior returned to an initiator endpoint in data center 102 (e.g., and stored in its ASDS cache) when the file was previously determined to be safe after performing static and/or dynamic analysis for the file. In this case, the BENIGN file verdict may have been previously returned to the initiator endpoint. The BENIGN file verdict may also be present in ASDS caches of other endpoints where the BENIGN verdict from the initiator endpoint was previously synchronized with an ASDS service, such as ASDS service 134 on security analyzer 132 illustrated in FIG. 1, and published from ASDS service 134 to other endpoints in data center 102 (e.g., and stored by each endpoint in their respective ASDS cache). As used herein, publishing verdicts to endpoints in data center 102 may include (1) broadcasting to all endpoints in data center 102, (2) synchronizing local ASDS caches of each endpoint with ASDS service 134 such that the verdict is provided to each local ADS cache, and/or (3) inserting the verdict into a central repository, such as database 136, to allow for an endpoint to retrieve the verdict for a file (e.g., when a cache miss occurs which is described in more detail below).

Also, a MALICIOUS file verdict for a file may have been previously published to endpoints in data center 102 (e.g., and stored in their respective ASDS caches) where the file was previously determined to be unsafe after performing static and/or dynamic analysis for the file. In this case, after determining the file exhibits MALICIOUS behavior, a MALICIOUS verdict for the file may have been provided to ASDS service 134 and published from ASDS service 134 to other endpoints in data center 102 (e.g., and stored by each endpoint in their respective ASDS cache). In certain aspects, a BENIGN verdict may only be published at a later time to all endpoints in data center 102, while MALICIOUS verdicts may be immediately published to all endpoints in data center 102, such that MALICIOUS files may be identified and immediately removed, to avoid the risk of such MALICIOUS files causing additional damage to components in data center 102.

ASDS caches 150, 128 make verdicts for previously inspected files readily available such that requests for a file verdict are returned faster than having to access the endpoint’s primary storage location. In other words, ASDS caches 150, 128 allow endpoints to efficiently reuse previously determined and published verdicts for files inspected in the environment.

Accordingly, at operation 208, security hub 118 or security hub 124 uses the calculated file hash to search ASDS cache 150 or ASDS cache 128 at the endpoint where security hub 118 or security hub 124 is implemented. Where at operation 210 the hash value is located in the cache (e.g., no cache miss), at operation 212, the verdict associated and stored with the hash value is retrieved. In cases where the endpoint retrieving the verdict is not the initiator endpoint, the retrieved verdict may be returned to the initiator endpoint to take appropriate action with respect to the file.

As mentioned, verdicts stored in the cache may be either BENIGN or MALICIOUS verdicts. Accordingly, where a MALICIOUS verdict is stored for the file hash, at operation 214, the initiator endpoint (e.g., in some cases, via an SVM on the initiator endpoint, such as SVM 113 illustrated in FIG. 1) may take a first policy action. The first policy action may be determined based on policies configured for endpoints in the environment at network manager 106. For example, the initiator endpoint may be configured to reset a connection, quarantine the file, delete/exterminate the file, not allow the file to run, and/or the like, where a MALICIOUS verdict is returned for the file hash. Similarly, where a BENIGN verdict is stored for the file hash, at operation 216, the initiator endpoint (e.g., in some cases, via SVM 113 on the initiator endpoint) may take a second policy action. The second policy action may be determined based on policies configured for endpoints in the environment at network manager 106. For example, the initiator endpoint may be configured to allow a file download, the opening of a file, the execution of a file, and/or the like, where a BENIGN verdict is returned for the file hash.

Alternatively, if the file hash for the file is not located in the cache (e.g., ASDS cache 150 or ASDS cache 128), the file may be considered to be an unknown file, or in other words the file is classified as an unknown file. In particular, the file is considered to be unknown because the file has not previously been inspected (e.g., no static and/or dynamic analysis of the file has previously been performed) to be classified as either BENIGN or MALICIOUS. Accordingly, a verdict for the file does not exist in the cache thereby making the file “unknown”.

If, at operation 210, the requested file hash is not found in the cache, in other words a cache miss occurs, then at operation 218, security hub 118 or 124 may select the unknown file for static and/or dynamic analysis and trigger initiation of the analysis(es). More specifically, in certain aspects, security hub 118, 124 may be triggered to pass the file (and its associated hash) to a static analyzer (e.g., such as static analyzer 120 at host 110 or static analyzer 126 at ESG 122 illustrated in FIG. 1) to perform static analysis on the unknown file, without sending the file to other sources for further analysis. In certain aspects, security hub 118, 124 may be triggered to pass the file (and its associated hash) to cloud trusted sources, such as Lastline cloud services 154 and/or Carbon Black cloud services 156, to perform dynamic analysis on the unknown file, without first sending the file to static analyzer 120, 126 and/or without sending the file to other sources for further analysis. In certain aspects, security hub 118, 124 may be triggered to pass the file (and its associated hash) to a static analyzer (e.g., such as static analyzer 120 at host 110 or static analyzer 126 at ESG 122 illustrated in FIG. 1) to perform static analysis on the unknown file and pass the file to cloud trusted sources, such as Lastline cloud services 154 and/or Carbon Black cloud services 156, for dynamic analysis where static analyzer 120, 126 determines dynamic analysis is necessary for the unknown file (e.g., in some cases, based on the verdict and/or confidence level of the verdict produced for the unknown file by static analyzer 120, 126), with or without sending the file to other sources for further analysis. Static and dynamic analysis may be performed on the unknown file to inspect the file for malicious content and produce a corresponding verdict based on the inspection. In certain aspects, any other suitable way of determining the unknown file is BENIGN or MALICIOUS may be used.

Optionally, at operation 220, prior to beginning static and/or dynamic analysis for the file, snapshot features may be initiated to capture a state of VM 112 on host 110 or ESG 122 in data center 102 where the file was downloaded. A snapshot may be used to capture VM 112 on host 110 or ESG in data center 102 as it appears at a given point in time, for example, prior to allowing the downloaded file to open. As mentioned previously, a snapshot captured prior to opening of the unknown file may be used to restore the machine to known working, uncompromised points where a verdict returned for the file (e.g., at a later time) indicates the file is MALICIOUS. In certain aspects, however, initiation of snapshot features may not be implemented and/or permitted; thus, a snapshot may not be taken.

At operation 222, the initiator endpoint (e.g., in some cases, via SVM 113 on the initiator endpoint) may determine hardening policies to apply to the file. The hardening policies may include a set of permissions assigned to the file, where the set of permissions indicates the authorization given to a file to access specific resources, such as CPU, memory, storage, and the like. In certain aspects, a set of permissions may include one or more permissions.

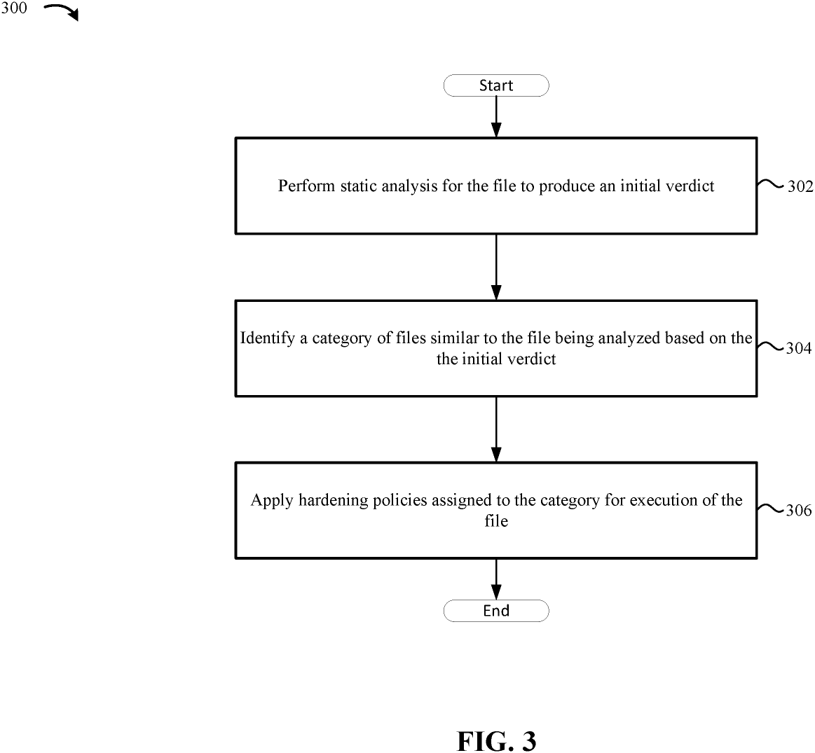

In certain aspects, the initiator endpoint may determine such hardening policies to apply to the file prior to beginning static and/or dynamic analysis for the file. In certain aspects, the initiator endpoint may determine such hardening policies to apply to the file subsequent to performing static analysis. In particular, FIG. 3 illustrates an example workflow 300 for determining hardening policies to apply to unknown files based on performing static analysis, according to an example embodiment of the present application. Workflow 300 of FIG. 3 may be performed, for example, by components of networking environment 100 illustrated in FIG. 1.

As shown in FIG. 3, at operation 302, static analysis may be performed by static analyzer 120, 126 for an unknown file. Static analyzer 120, 126 may perform the static analysis prior to determining, as well as applying, the determined hardening policies for the file.

At operation 304, a verdict produced by static analyzer 120, 126 in performing static analysis for the file may be used to determine which pre-determined category of files the file being analyzed in most similar to. A verdict, a score, or any combination thereof produced by static analyzer 120, 126 subsequent to performing static analysis for the file may be used to determine the similarity of the file to other files in each category. In certain aspects, the score may represent a confidence level of static analyzer 120, 126 in identifying that the file is safe or unsafe. In certain aspects the score may represent a threat level of the file, wherein such threat levels fall between a known BENIGN file threat (e.g., a score of zero) and a known MALICIOUS file threat (e.g., a score of ten).

As an illustrative example, a policymaker may have previously identified three categories of files based on their corresponding scores produced after performing static analysis for the file. A first category may include files which received a score of between, and including, 1 and 3 (e.g., a high confidence level the file is BENIGN), a second category may include files which received a score of between, and including, 4 and 6 (e.g., an intermediate confidence level the file is BENIGN), and a third category may include files which received a score of between, and including, 7 and 10 (e.g., a low confidence level the file is BENIGN). The policymaker may have also previously assigned hardening policies to each of these categories which are to be applied to files which fall within each of these categories. Accordingly, in this example, assuming the unknown file for which static analyzer 120, 126 performed static analysis on received a score of 6, at operation 304, the unknown may file be identified as a file which falls within the second category (e.g., including files which received a score of between and including 4 and 6). Thus, at operation 306, the hardening policies assigned to the second category may be applied to the unknown file.

Accordingly, where determining hardening policies is based on results of performing static analysis for a file, the hardening policies determined for each unknown file at operation 222 in FIG. 2A may not be the same (e.g., where static analysis for a first file returns a different verdict and/or different score than a verdict and/or score, respectively, returned for a second file).

In certain aspects, the hardening policies may contain a reduced set of permissions which ensure that resources of the system cannot be compromised in cases where a MALICIOIUS file is encountered. Accordingly, the reduced set of permissions described herein may not be tied to the properties of the file for which the permissions are to apply, but instead to the needs and security of the system. Thus, the hardening policies determined for each unknown file at operation 222 may be determined, irrespective of permissions requested by the file and/or functions to be performed by the file during execution.

In certain aspects, the hardening policies may be determined by identifying permissions which the file requests, and analyzing whether each requested permission has the ability to compromise resources of the system. Permissions which may lead to a MALICIOUS file compromising the system may be restricted permissions in the hardening policies applied to the file. In other words, only the reduced permissions requested by the file such that the file may perform reduced (e.g., minimal) functions without compromising the system may be permissions contained in the hardening policies determined for the file.

An example hardening policy to be applied to an unknown file may include a policy involving a limit on network traffic. For example, the policy may restrict an unknown file from lateral network movement, or in other words restrict the unknown file from engaging in east-west movement to other endpoints and/or devices in data center 102. In some cases, malware, after gaining access to an endpoint, may attempt to control the endpoint and use lateral movement mechanisms to spread to other endpoints and critical assets of a data center. Accordingly, by limiting the lateral movement of the unknown file, security risks, by allowing this unknown file to open, may be lessened.

Another example hardening policy to be applied to an unknown file may include a policy involving file systems in data center 102. In order to keep safe user data from improper access, the policy may use one or more limitations, including limiting the types of access to data in the file system, limiting the number of users which may gain access to data in the file system, and/or limiting access to the file system based on knowledge of a password or any other secret code. For example, limits on the type of access may include allowing an unknown file to (1) read from a file in the file system, (2) write/re-write files to the file system, (3) load and execute files in the file system, (4) delete files in the file system, and/or the like. Further, in certain aspects, limits on the number of users which may gain access to data in the file system may be based on user identifiers (IDs) of users which have downloaded the unknown file. In particular, specific user IDs (e.g., user IDs of trusted security engineers) may be granted sole access, or greater access to data in the file system, than other user IDs.

Another example hardening policy to be applied to an unknown file may include a policy involving CPU. For example, the policy may restrict an unknown file from monopolizing available CPU on an endpoint, a subset of endpoints, and/or in data center 102. In certain aspects, the policy may restrict CPU usage to a percentage of total CPU (e.g., gigahertz) available on an endpoint, a subset of endpoints, and/or in data center 102. As an illustrative example, where the unknown file contains malware, such as a virus or a worm, the unknown file may seek to replicate itself for purposes of spreading to other devices and/or other endpoints in data center 102, causing a depletion of available CPU. Accordingly, by applying the hardening policy which limits CPU usage, the malware contained in the unknown file may be restricted from such replication and movement.

Another example hardening policy to be applied to an unknown file may include a policy involving memory. For example, the policy may restrict an unknown file from monopolizing available memory on an endpoint, a subset of endpoints, and/or in data center 102. In certain aspects, the policy may restrict memory usage to a percentage of total memory available on an endpoint, a subset of endpoints, and/or in data center 102.

Another example hardening policy to be applied to an unknown file may include a policy involving snapshots. For example, where snapshot features are not implemented and/or where a snapshot cannot be taken (e.g., initiated at operation 220), the policy may restrict opening of the unknown file until a BENIGN verdict is returned for the file. As mentioned, a snapshot captured prior to opening of an unknown file may be used to restore the machine to known working, uncompromised points where a verdict returned for the file (e.g., at a later time) indicates the file is MALICIOUS. Thus, where a snapshot cannot be taken, the unknown file may not be opened, given no snapshot exists to return the system back to an uncompromised state should the unknown file contain MALICIOUS content.

Any other suitable hardening policies may be considered to restrict permissions of an unknown file for purposes of mitigating the security risk imposed by an unknown file, should the unknown file contain malware.

At operation 224, hardening policies determined at operation 222 may be applied to the unknown file, and the unknown file may be allowed to execute based on the applied hardening policies. By allowing a user to download, open, execute, etc. the unknown file with reduced permissions, prior to receiving the verdict for the file, user experience may not be tainted.

Although workflow 200 illustrates operation 220 and 222 occurring after operation 218, in certain embodiments, operations 218, 220, and 222 may be performed at the same time and/or in a different order than what is illustrated in workflow 200. In certain aspects, operation 220 may not be performed.

At operation 226 (e.g., illustrated in FIG. 2B), a verdict for the file previously having an unknown verdict may be returned based on static and/or dynamic analysis performed on the file. In particular, an endpoint (e.g., the initiator endpoint or another endpoint) through static analyzer 120, 126 may inspect and test the file to better understand characteristics and behaviors of the file to categorize the file as “safe” (e.g., BENIGN) or “unsafe” (e.g., MALICIOUS). The endpoint, via static analyzer 120, 126, may produce an outcome verdict for the file following this analysis. In certain aspects, the endpoint may receive a verdict for the unknown file based on dynamic analysis performed for the file by other trusted sources, such as Lastline cloud services 154 and Carbon Black cloud services 156. In cases where the endpoint retrieving the verdict is not the initiator endpoint, the retrieved verdict may be returned to the initiator endpoint to take appropriate action with respect to the file.

Where at operation 228 the verdict returned for the file is BENIGN, at operation 230, the verdict for the file is added to the ASDS cache on the endpoint where the file was downloaded (e.g., at operation 202 in FIG. 2A), such as ASDS cache 150 on host 110 or ASDS cache 128 on ESG 122. As mentioned previously, a BENIGN file verdict for a file may be returned to an initiator endpoint in data center 102 (e.g., and stored in its ASDS cache) where the file is determined to be safe after performing static and/or dynamic analysis for the file. In certain aspects, in contrast, a MALICIOUS file verdict may be published to all endpoints in data center 102 (e.g., and stored in their respective ASDS caches) when the file is determined to be unsafe after performing static and/or dynamic analysis for the file.

At operation 232, the initiator endpoint (e.g., in some cases, via SVM 113 on the initiator endpoint) may determine relaxed (e.g., loosened) policies to apply to the file. The relaxed policies may include a set of permissions assigned to the file, where the set of permissions indicates the authorization given to a file to access specific resources, such as CPU, memory, storage, and the like.

In certain aspects, the initiator endpoint may determine such relaxed policies to apply to the file subsequent to performing static analysis (e.g., where dynamic analysis is not performed on the file). In particular, as described in more detail with respect to FIG. 3, in certain aspects, static analysis may be performed by static analyzer 120, 126 for the file to produce a verdict. In some cases, static analyzer 120, 126 may determine dynamic analysis of the file is not necessary; thus, only static analysis may be performed for the file.

In certain other aspects, the initiator endpoint may determine such relaxed policies to apply to the file subsequent to performing static and dynamic analysis. In particular, the initiator endpoint may wait until a verdict is produced by static analyzer 120, 126, and subsequently a verdict is produced by other trusted sources, such as Lastline cloud services 154 and Carbon Black cloud services 156, prior to determining relaxed policies to apply to the file.

The relaxed policies determined and applied to the file may be based on a verdict, a score, or any combination thereof produced by static analyzer 120, 126 subsequent to performing static analysis for the file or a verdict, a score, or any combination thereof produced by other trusted sources performing dynamic analysis for the file. In certain aspects, the score may represent a confidence level of static analyzer 120, 126 or other trusted sources in identifying that the file is safe or unsafe. In certain aspects the score may represent a threat level of the file, wherein such threat levels fall between a known BENIGN file threat (e.g., a score of zero) and an unknown BENIGN file threat (e.g., a score of ten). Accordingly, the relaxed policies determined for each file at operation 232 may not be the same (e.g., where static and/or dynamic analysis for a first file returns a different verdict and/or different score than a verdict and/or score, respectively, returned for a second file).

In certain aspects, the relaxed policies may include a set of permissions assigned to the file that include more permissions than hardening permissions assigned to the file. For example, as mentioned, an example hardening policy may restrict an unknown file from lateral network movement. Where the unknown file is determined to be BENIGN, this example hardening policy may be relaxed such that the relaxed policies applied to the file grant the file additional permissions not originally granted with respect to the hardening policies. For example, the relaxed policies may allow the file classified as BENIGN to now move laterally (e.g., east-west) through data center 102.

In certain aspects where a score, in addition to the verdict, is returned at operation 226, the score may be similarly added to the ASDS cache (e.g., along with the verdict at operation 230) on the endpoint where the file was downloaded (e.g., at operation 202 in FIG. 2A), such as ASDS cache 150 on host 110 or ASDS cache 128 on ESG 122.

At operation 234, relaxed policies determined at operation 222 may be applied to the file, and the file may be allowed to continue execution based on the applied relaxed policies. In other words, a user may continue to download, open, execute, etc. the file with the new relaxed policies applied. Accordingly, in some cases, execution of the file with such relaxed policies may allow the application to perform one or functions which the application was unable to perform where hardened policies were applied.

At operation 236, the snapshot taken at operation 220 may be deleted. The previously taken snapshot may not be used given the file is determined to be BENIGN; thus, restoring the machine to previous working points may not be necessary (e.g., given malicious activity did not occur between when the file was allowed to be opened and when the verdict for the file was returned).

At a later time, at operation 238, ASDS cache 150, 128 containing the BENIGN verdict for the previously-unknown file is synchronized with ASDS service 134 of security analyzer 132 to add the BENIGN verdict for the file to database 136. The BENIGN file verdict added to database 136 may be further published to other endpoints in data center 102 so that each endpoint in data center 102 may add the BENIGN file verdict to their corresponding ASDS cache 150, 128. Recording the BENIGN file verdict in each ADS cache 150, 128 of each endpoint may allow for the verdict for the file to be located where the same file is subsequently downloaded.

In certain aspects, at operation 238, ASDS cache 150, 128 containing a score for the previously-unknown file is also synchronized with ASDS service 134 of security analyzer 132 to add the score for the file to database 136, such that the score may be further published to other endpoints in data center 102. Other endpoints may use this published score to determine relaxed policies to apply to a same file that is downloaded at that endpoint. Each endpoint in data center 102 may also add the score to their corresponding ASDS cache 150, 128.

Returning back to operation 228, where at operation 228 the verdict returned for the file is MALICIOUS, at operation 240 and operation 242, the MALICIOUS verdict for the file is provided to ASDS service 134 and published from ASDS service 134 to other endpoints in data center 102 (e.g., and stored by each endpoint in their respective ASDS cache 150, 128). The MALICIOUS file verdict is also added to database 136 at security analyzer 132. In certain aspects, MALICIOUS verdicts are immediately published to all endpoints in data center 102, such that MALICIOUS files may be identified and immediately removed, to avoid the risk of such MALICIOUS files causing additional damage to components in data center 102.

At operation 244, in response to receiving the MALICIOUS verdict associated with the file, SVM 113 on host 110 may take action based on the first policy configured for endpoints in the in data center 102 at network manager 106. For example, as mentioned previously, host 110, via SVM 113, may reset a connection, quarantine the file, delete/exterminate the file, not allow the file to run, and/or the like, where the MALICIOUS verdict is returned.

In certain aspects, taking action may further include, at operation 246, restoring the machine to known working, uncompromised points where a snapshot was previously captured for the machine at operation 220 (e.g., illustrated in FIG. 2A). In particular, any malicious activity occurring between when the file was allowed to be opened and when the verdict for the file was returned may be cleaned up, such that data center 102 exists as if the MALICIOUS file never existed and/or was opened in the first place. In certain aspects, taking action may further include, at operation 248, deleting the snapshot where a snapshot was previously captured at operation 220.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can be a non-transitory computer readable medium. The computer readable medium can also be distributed over a network coupled computer system so that the computer readable code is stored and executed in a distributed fashion. In particular, one or more embodiments may be implemented as a non-transitory computer readable medium comprising instructions that, when executed by one or more processors of a computing system, cause the computing system to perform a method, as described herein.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel’s functionality to make use of resource isolation (CPU, memory, block I/O, network, etc.) and separate namespaces and to completely isolate the application’s view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method for assigning permissions to files in a malware detection system comprising:
assigning a first subset of permissions to a first file classified as an unknown file;
opening the first file in accordance with the first subset of permissions;
determining a first verdict for the first file, the first verdict indicating the first file is benign;
assigning a second subset of permissions to the first file based on determining the first verdict indicating the first file is benign; and
executing the first file in accordance with the second subset of permissions.

2. The method of claim 1, wherein the first subset of permissions assigned to the first file comprises a minimum set of permissions to open the first file.

3. The method of claim 1, further comprising:
determining a second verdict for the first file based on static analysis of the first file, wherein the first subset of permissions is based, at least in part, on the second verdict; and
wherein the first verdict is determined based on dynamic analysis of the first file.

4. The method of claim 1, wherein at least one of the first subset of permissions or the second subset of permissions comprises permissions indicating an authorization given to the first file to at least one of:
access central processing unit (CPU),
access memory,
access storage, or
engage in lateral movement through the malware detection system.

5. The method of claim 1, wherein the first subset of permissions comprises less permissions than the second subset of permissions.

6. The method of claim 1, further comprising:
determining a score for the first file, the score indicating:
a confidence level of the first verdict for the first file, or
a threat level of the first file, wherein the second subset of permissions is based on the score.

7. The method of claim 1, further comprising:
assigning a third subset of permissions to a second file classified as an unknown file;
capturing a snapshot of a machine prior to opening, at the machine, the second file;
opening, at the machine, the second file in accordance with the third subset of permissions;
determining a second verdict for the second file, the second verdict indicating the second file is malicious, wherein during a time between opening the second file and determining the second verdict, the second file carried out one or more malicious activities; and
restoring the machine to a point in time prior to the second file carrying out the one or more malicious activities using the snapshot.

8. A system comprising:
one or more processors; and
at least one memory, the one or more processors and the at least one memory configured to cause the system to:
assign a first subset of permissions to a first file classified as an unknown file;
open the first file in accordance with the first subset of permissions;
determine a first verdict for the first file, the first verdict indicating the first file is benign;
assign a second subset of permissions to the first file based on determining the first verdict indicating the first file is benign; and
execute the first file in accordance with the second subset of permissions.

9. The system of claim 8, wherein the first subset of permissions assigned to the first file comprises a minimum set of permissions to open the first file.

10. The system of claim 8, wherein the one or more processors and the at least one memory are further configured to cause the system to:
determine a second verdict for the first file based on static analysis of the first file, wherein the first subset of permissions is based, at least in part, on the second verdict; and
wherein the first verdict is determined based on dynamic analysis of the first file.

11. The system of claim 8, wherein at least one of the first subset of permissions or the second subset of permissions comprises permissions indicating an authorization given to the first file to at least one of:
access central processing unit (CPU),
access memory,
access storage, or
engage in lateral movement.

12. The system of claim 8, wherein the first subset of permissions comprises less permissions than the second subset of permissions.

13. The system of claim 8, wherein the one or more processors and the at least one memory are further configured to cause the system to:
determine a score for the first file, the score indicating:
a confidence level of the first verdict for the first file, or
a threat level of the first file, wherein the second subset of permissions is based on the score.

14. The system of claim 8, wherein the one or more processors and the at least one memory are further configured to cause the system to:
assign a third subset of permissions to a second file classified as an unknown file;
capture a snapshot of a machine prior to opening, at the machine, the second file;
open, at the machine, the second file in accordance with the third subset of permissions;
determine a second verdict for the second file, the second verdict indicating the second file is malicious, wherein during a time between opening the second file and determining the second verdict, the second file carried out one or more malicious activities; and
restore the machine to a point in time prior to the second file carrying out the one or more malicious activities using the snapshot.

15. A non-transitory computer-readable medium comprising instructions that, when executed by one or more processors of a computing system, cause the computing system to perform operations for assigning permissions to files in a malware detection system, the operations comprising:
assigning a first subset of permissions to a first file classified as an unknown file;
opening the first file in accordance with the first subset of permissions;
determining a first verdict for the first file, the first verdict indicating the first file is benign;
assigning a second subset of permissions to the first file based on determining the first verdict indicating the first file is benign; and
executing the first file in accordance with the second subset of permissions.

16. The non-transitory computer-readable medium of claim 15, wherein the first subset of permissions assigned to the first file comprises a minimum set of permissions to open the first file.

17. The non-transitory computer-readable medium of claim 15, wherein the operations further comprise:
determining a second verdict for the first file based on static analysis of the first file, wherein the first subset of permissions is based, at least in part, on the second verdict; and
wherein the first verdict is determined based on dynamic analysis of the first file.

18. The non-transitory computer-readable medium of claim 15, wherein at least one of the first subset of permissions or the second subset of permissions comprises permissions indicating an authorization given to the first file to at least one of:
access central processing unit (CPU),
access memory,
access storage, or
engage in lateral movement through the malware detection system.

19. The non-transitory computer-readable medium of claim 15, wherein the first subset of permissions comprises less permissions than the second subset of permissions.

20. The non-transitory computer-readable medium of claim 15, wherein the operations further comprise:
determining a score for the first file, the score indicating:
a confidence level of the first verdict for the first file, or
a threat level of the first file, wherein the second subset of permissions is based on the score.
